(19) United States
(12) Patent Application Publication
(10) Pub. No.: US 2022/0131150 A1
(43) Pub. Date: Apr. 28, 2022

(54) CELLULOSE DERIVATIVE COMPOSITION FOR SECONDARY BATTERY BINDER AND METHOD OF PREPARING COMPOSITION FOR SECONDARY BATTERY ELECTRODE COMPRISING THE SAME

(71) Applicants: ELECTRONICS AND TELECOMMUNICATIONS RESEARCH INSTITUTE, Daejeon (KR); UNIST (ULSAN NATIONAL INSTITUTE OF SCIENCE AND TECHNOLOGY), Ulsan (KR)

(72) Inventors: Young-Gi LEE, Daejeon (KR); Sung You HONG, Ulsan (KR); Min Pyeong KIM, Bucheon-si (KR); Dong Ok SHIN, Sejong-si (KR); Ju Young KIM, Sejong-si (KR); Juhye SONG, Daejeon (KR); Ho Seung LEE, Incheon (KR)

(73) Assignees: ELECTRONICS AND TELECOMMUNICATIONS RESEARCH INSTITUTE, Daejeon (KR); UNIST (ULSAN NATIONAL INSTITUTE OF SCIENCE AND TECHNOLOGY), Ulsan (KR)

(21) Appl. No.: 17/458,926

(22) Filed: Aug. 27, 2021

(30) Foreign Application Priority Data
Oct. 26, 2020 (KR) 10-2020-0139575
Apr. 2, 2021 (KR) 10-2021-0043475

(51) Int. Cl. H01M 4/62; H01M 4/583; C08L 1/28; C08L 9/06; C08B 11/12; H01M 10/0525; H01M 4/04

(52) U.S. Cl. CPC H01M 4/622; H01M 4/583; C08L 1/286; H01M 4/04; C08B 11/12; H01M 10/0525; C08L 9/06

(57) ABSTRACT

Provided is a cellulose derivative composition for a secondary battery binder, a method of preparing a composition for a secondary battery electrode, including the same, and a secondary battery including the same. According to the inventive concept, the cellulose derivative composition for a secondary battery binder may include a compound represented by Formula 1 below.

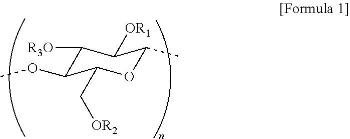

### CROSS-REFERENCE TO RELATED APPLICATIONS

This U.S. non-provisional patent application claims priority under 35 U.S.C. § 119 of Korean Patent Application Nos. 10-2020-0139575 filed on Oct. 26, 2020, and 10-2021-0043475, filed on Apr. 2, 2021, the entire contents of which are hereby incorporated by reference.

### BACKGROUND

The present disclosure herein relates to a cellulose derivative composition for a secondary battery binder and a method of preparing a composition for a secondary battery electrode including the same.

Lithium ion secondary batteries are used as core power sources of portable electronic communication devices such as mobile phones and laptops. Compared to other energy storages such as capacitors and fuel cells, the lithium ion secondary batteries show high storage capacity, excellent charging and discharging characteristics and high processability and receive much attention as a next-generation energy storage device such as a wearable device and an energy storage system (ESS).

A lithium secondary battery is a battery composed of a positive electrode, a negative electrode, an electrolyte providing a moving passage of lithium ions between the positive electrode and the negative electrode, and a separator, and by oxidation and reduction reactions during the intercalation/deintercalation of lithium ions at the positive electrode and the negative electrode, electric energy is produced. In the lithium secondary battery, a lithium metal having high energy density becomes the negative electrode, and a liquid solvent becomes the electrolyte. At present, in the lithium secondary battery, an organic liquid electrolyte is used as the driving element of a high-performance and high-energy storage device. Recently, due to environmental issues and for the saving of manufacturing costs, development on a process for preparing a binder included in a slurry for manufacturing an electrode of a secondary battery is conducted.

### SUMMARY

The present disclosure provides a cellulose derivative composition for a secondary battery binder, minimizing the formation of the microgels of a cellulose derivative.

The present disclosure also provides a method of preparing a composition for a secondary battery electrode, improving an initial wetting rate and a dissolution rate and improving the efficiency of a preparation process.

The present disclosure also provides a secondary battery having improved reliability.

The tasks to be solved by the present inventive concept is not limited to the above-described tasks, however other tasks not mentioned will be precisely understood from the description below by a person skilled in the art.

An embodiment of the inventive concept provides a cellulose derivative composition for a secondary battery binder, including a compound represented by Formula 1 below.

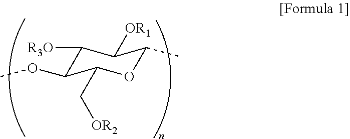

In Formula 1, R₁, R₂, and R₃ are each independently any one among a metal salt functional group including a sulfur (S) element, a metal salt functional group including a phosphorus (P) element, a metal salt functional group including a boron (B) element, a metal salt functional group including a carboxymethyl group, and hydrogen, at least one among R₁, R₂, and R₃ is a metal salt functional group including a sulfur (S) element, a metal salt functional group including a phosphorus (P) element, a metal salt functional group including a boron (B) element, or a metal salt functional group including a carboxymethyl group, and “n” is an integer of 1 or more.

In an embodiment, the metal salt functional group including a sulfur (S) element may be a metal salt functional group including sulfonate (SO₃²⁻) or sulfate (SO₄²⁻), and the metal salt functional group including a phosphorus (P) element may be a metal salt functional group including phosphite (PO₃³⁻) or phosphate (PO₄³⁻).

In an embodiment, the metal salt functional group including a sulfur (S) element may be any one among

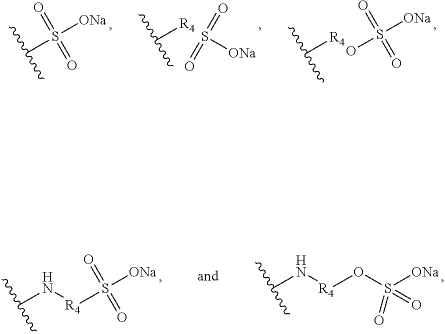

where R₄ may be a hydrocarbon group of 1 to 10 carbon atoms.

In an embodiment, the metal salt functional group including a phosphorus (P) element may be any one among

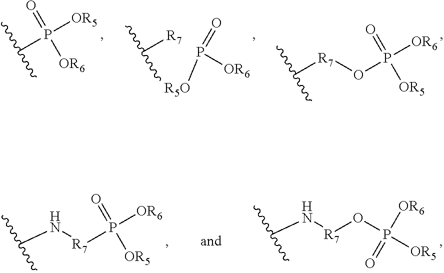

where R₅ and R₆ may be each independently hydrocarbon of 1 to 10 carbon atoms or Na, and R₇ may be hydrocarbon of 1 to 10 carbon atoms.

In an embodiment, the metal salt functional group including a boron (B) element may be any one among

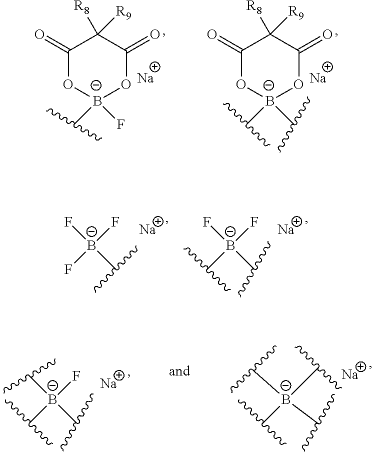

where R₈ and R₉ may be each independently hydrocarbon of 1 to 10 carbon atoms, or a halogen element.

In an embodiment, a metal of the metal salt may be Na.

In an embodiment of the inventive concept, a method of preparing a composition for a secondary battery electrode, includes: preparing an aqueous solution including a cellulose derivative composition including a compound represented by Formula 1 below; adding an active material to the aqueous solution of the cellulose derivative and stirring to prepare a first slurry; and adding an emulsion to the first slurry and stirring.

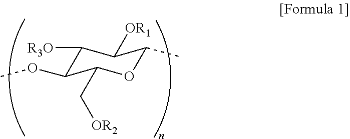

In Formula 1, R₁, R₂, and R₃ are each independently any one among a metal salt functional group including a sulfur (S) element, a metal salt functional group including a phosphorus (P) element, a metal salt functional group including a boron (B) element, a metal salt functional group including a carboxymethyl group and hydrogen, at least one among R₁, R₂, and R₃ is a metal salt functional group including a sulfur (S) element, a metal salt functional group including a phosphorus (P) element, a metal salt functional group including a boron (B) element, or a metal salt functional group including a carboxymethyl group, and “n” is an integer of 1 or more.

In an embodiment, the emulsion may be a styrene-butadiene rubber (SBR) emulsion.

In an embodiment, the active material may include at least one of graphite, hard carbon, or soft carbon.

In an embodiment, the aqueous solution including the cellulose derivative composition may include an organic solvent, and the organic solvent may include at least one of acetonitrile, dimethyl acetamide, dimethyl formamide, dimethyl sulfoxide, isopropanol, dioxane, or tetrahydrofuran.

In an embodiment, the preparation of the aqueous solution including the cellulose derivative composition may include adding a reactant to a precursor material of the cellulose derivative, and performing reaction.

In an embodiment, the precursor material of the cellulose derivative may include at least one of cellulose, methyl cellulose, ethyl cellulose, butyl cellulose, hydroxypropyl cellulose, cellulose nitrate, cellulose acetate, cellulose acetate propionate, cellulose acetate butyrate, carboxymethyl cellulose, or derivatives thereof.

In an embodiment, the reactant may include at least one of a reactant including a sulfur (S) element, a reactant including a phosphorus (P) element, a reactant including a boron (B) element, or a reactant including a carboxymethyl group.

In an embodiment, the reactant including a sulfur (S) element may include at least one of a sulfur trioxide pyridine complex, a sulfur trioxide triethylamine complex, a sulfur trioxide trimethylamine complex, a sulfur trioxide N,N-dimethylformamide complex, a sulfur trioxide N-ethyldiisopropylamine complex, 2-chloroethanesulfonic acid, bromoethanesulfonic acid, 4-iodobenzenesulfonic acid, 3-iodobenzenesulfonic acid, 2-iodobenzenesulfonic acid, 4-bromobenzenesulfonic acid, 3-bromobenzenesulfonic acid, 2-bromobenzenesulfonic acid, saclofen, 4-chloroaniline-3-sulfonic acid, 5-amino-2-chloro-4-methylbenzenesulfonic acid, 5-amino-2-bromo-4-methylbenzenesulfonic acid, or bromaminic acid.

In an embodiment, the reactant including a phosphorus (P) element may include at least one of phosphoric acid, triethyl phosphate, diethyl phosphate, tripropyl phosphate, phosphorus(V) oxychloride, diethyl chlorophosphite, dimethyl chlorophosphite, diisopropyl chlorophosphite, diphenyl phosphoryl chloride, ethyl dichlorophosphate, diphenylphosphinic chloride, diethyl cyanophosphonate, or diethyl methyl phosphate.

In an embodiment, the reactant including a boron (B) element may include at least one of sodium fluoromalonate difluoroborate, sodium chloromalonate difluoroborate, sodium bromomalonate difluoroborate, sodium iodomalonate difluoroborate, sodium dimethylmalonate difluoroborate, sodium propenymalonate difluoroborate, sodium fluoromethylmalonate difluoroborate, sodium trifluoromethylmaloate difluoroborate, sodium phenylmalonate difluoroborate, or sodium propenylfluoromalonate difluoroborate.

In an embodiment, the preparation of the aqueous solution including the cellulose derivative composition including a compound represented by Formula 1 may include: adding an activation additive to the precursor material of the cellulose derivative and performing an activation process; and adding a reactant and performing reaction.

In an embodiment, the activation additive may include p-toluenesulfonic acid anhydride, or p-toluenesulfonic acid monohydrate.

In an embodiment, a viscosity of the composition for a secondary battery electrode may be from about 1000 cP to about 9000 cP.

In an embodiment of the inventive concept, a secondary battery includes: a positive electrode; a negative electrode; and an electrolyte layer disposed between the positive electrode and the negative electrode, wherein the negative electrode includes an active material and a mixture binder, the mixture binder includes a cellulose derivative composition including a compound represented by Formula 1 below and a styrene-butadiene rubber (SBR) emulsion.

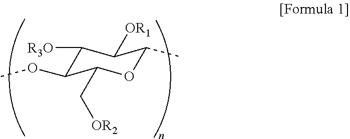

In Formula 1, R₁, R₂, and R₃ are each independently any one among a metal salt functional group including a sulfur (S) element, a metal salt functional group including a phosphorus (P) element, a metal salt functional group including a boron (B) element, a metal salt functional group including a carboxymethyl group and hydrogen, at least one among R₁, R₂, and R₃ is a metal salt functional group including a sulfur (S) element, a metal salt functional group including a phosphorus (P) element, a metal salt functional group including a boron (B) element, or a metal salt functional group including a carboxymethyl group, and “n” is an integer of 1 or more.

### BRIEF DESCRIPTION OF THE FIGURES

The accompanying drawings are included to provide a further understanding of the inventive concept, and are incorporated in and constitute a part of this specification. The drawings illustrate embodiments of the inventive concept and, together with the description, serve to explain principles of the inventive concept. In the drawings:

FIG. 1 is a cross-sectional view showing a secondary battery according to an embodiment of the inventive concept;

FIG. 2 is a flowchart for explaining a method of preparing a composition for a secondary battery electrode according to an embodiment of the inventive concept;

FIG. 3 is a graph showing FT-IR spectrum results of Example 1 and Comparative Example 1;

FIG. 4 is a graph showing XPS data results of Example 1;

FIG. 5 is a graph showing S2p XPS data results of Example 1;

FIG. 6 is a graph showing GPC data results of Example 1 and Comparative Example 1;

FIG. 7 shows measured results on the number of microgels with the naked eye after applying solutions immediately after stirring and dissolving the same amounts of Example 1 to Example 3, and Comparative Example 1 for about 20 minutes, on transparent films;

FIG. 8 shows measured results on adhesion through a peel test after saturation immersing each of negative electrode to which each of the mixture binders of Example 4 to Example 6, and Comparative Example 2 is applied, in a liquid electrolyte;

FIG. 9 is a graph on initial discharge capacity after constituting a single cell using each negative electrode to which each of the mixture binders of Example 4 to Example 6, and Comparative Example 2 is applied; and

FIG. 10 is a graph on life characteristics after constituting a single cell using each negative electrode to which each of the mixture binders of Example 4 to Example 6, and Comparative Example 2 is applied.

### DETAILED DESCRIPTION

The above objects, features and methods for accomplishing thereof of the inventive concept will be clarified referring to embodiments below with reference to the accompanying drawings. The inventive concept may, however, be embodied in different forms and should not be construed as limited to the embodiments set forth herein. Rather, embodiments are provided so that the contents disclosed herein become thorough and complete, and the spirit of the inventive concept is sufficiently accepted for a person skilled in the art. The inventive concept is defined by the scope of claims, and like reference numerals refer to like elements for explaining each drawing throughout.

The terminology used herein is for the purpose of describing particular embodiments only and is not intended to be limiting of the invention. As used herein, the singular forms, are intended to include the plural forms as well, unless the context clearly indicates otherwise. It will be further understood that the terms “comprises” and/or “comprising”, when used in this specification, specify the presence of stated elements, steps, operations, and/or devices, but do not preclude the presence or addition of one or more other elements, steps, operations, and/or devices.

It will be understood that when a film (or layer) is referred to as being “on” another film (or layer), the film (or layer) can be directly on the other film (or layer), or intervening films (or layers) may be present.

In addition, the embodiments described in the present disclosure will be explained referring to cross-sectional views and/or plan views of ideal illustrations of the inventive concept. In the drawings, the thicknesses of layers and areas are exaggerated for effective explanation of the technical contents. Accordingly, the shape of the illustrations may be deformed by manufacturing technique and/or tolerance. Accordingly, the embodiments of the inventive concept are not limited to the illustrated specific shapes but include changed shapes produced according to a manufacturing process. Therefore, the regions shown in the drawings have schematic property, the shape of the regions illustrated are for showing the specific shape of the regions of a device, but are not intent to limit the scope of the invention.

The terms used in the embodiments of the inventive concept may be interpreted as commonly known meanings to a person skilled in the art unless otherwise defined.

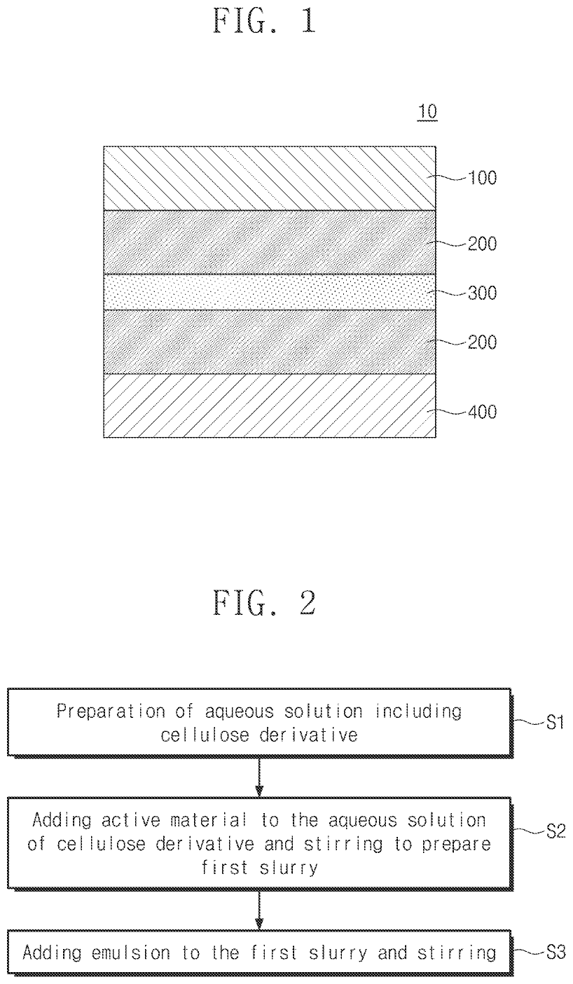

FIG. 1 is a cross-sectional view showing a secondary battery according to an embodiment of the inventive concept.

Referring to FIG. 1, a secondary battery 10 may include a positive electrode 100, an electrolyte layer 200, a separator 300, and a negative electrode 400. The positive electrode 100 and the negative electrode 400 may be separately disposed and may be opposite to each other. The electrolyte layer 200 may be disposed between the positive electrode 100 and the separator 300, and between the separator 300 and the negative electrode 400.

The secondary battery 10 may be, for example, a lithium secondary battery. The positive electrode 100 may include a positive electrode active material. The positive electrode active material may include at least one of sulfur, LiCoO₂, LiNiO₂, LiNiₓCo_{y}Mn_{z}O₂ (x+y+z=1), LiMn₂O₄, or LiFePO₄.

The positive electrode 100 may further include an organic binder and a conductive material. The organic binder and the conductive material may improve the mechanical adhesion and electroconductivity of the positive electrode 100. For example, the organic binder may include fluorine-based polymers, for example, polyvinylidene fluoride (PVdF). For example, the conductive material may include at least one of conductive amorphous carbon, carbon nanotube, or graphene. For example, the amount ratio of active material:organic binder:conductive material in the positive electrode may be about 80:10:10 to about 96:2:2.

The negative electrode 400 may include a negative active material. The negative electrode active material may include at least one of graphite, hard carbon, or soft carbon.

The negative electrode 400 may further include a mixture binder composition. The mixture binder composition may include a cellulose derivative composition and a styrene-butadiene rubber (SBR) emulsion. Accordingly, the mixture binder composition may be a mixture aqueous binder. The mixture aqueous binder of the inventive concept may be applied to a graphite-based negative electrode for a secondary battery. More particularly, the mixture aqueous binder of the inventive concept may be a mixture aqueous binder prepared by synthesizing cellulose derivatives which are substituted with various functional groups and mixing thereof with a styrene-butadiene rubber emulsion.

The cellulose derivative composition may include a compound represented by Formula 1 below.

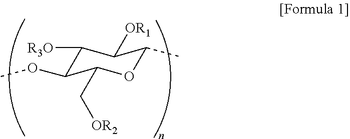

In Formula 1, R₁, R₂, and R₃ may be each independently any one among a metal salt functional group including a sulfur (S) element, a metal salt functional group including a phosphorus (P) element, a metal salt functional group including a boron (B) element, a metal salt functional group including a carboxymethyl group, and hydrogen. At least one among R₁, R₂, and R₃ may be a metal salt functional group including a sulfur (S) element, a metal salt functional group including a phosphorus (P) element, a metal salt functional group including a boron (B) element, or a metal salt functional group including a carboxymethyl group. In this case, “n” may be an integer of 1 or more.

The repeating unit of the cellulose derivative may be a cellulose-based repeating unit group including a hydroxyl group, and R₁, R₂, and R₃ may be functional groups substituting for the hydroxyl groups in the repeating unit group. For example, the metal of the metal salt may be Na.

In some embodiments, 0 to 2 among R₁, R₂, and R₃ may include hydrogen. In this case, if two among R₁, R₂, and R₃ are hydrogen atoms, the remaining one may be a metal salt functional group including a sulfur (S) element, a metal salt functional group including a phosphorus (P) element, or a metal salt functional group including a boron (B) element.

In some embodiments, 0 to 2 among R₁, R₂, and R₃ may include metal salt functional groups including carboxymethyl groups. In this case, if two among R₁, R₂, and R₃ are metal salt functional groups including carboxymethyl groups, the remaining one may be a metal salt functional group including a sulfur (S) element, a metal salt functional group including a phosphorus (P) element, or a metal salt functional group including a boron (B) element.

In some embodiments, 0 to 3 among R₁, R₂, and R₃ may include metal salt functional groups including a sulfur (S) element. In some embodiments, 0 to 3 among R₁, R₂, and R₃ may include metal salt functional groups including a phosphorus (P) element. In some embodiments, 0 to 3 among R₁, R₂, and R₃ may include metal salt functional groups including a boron (B) element.

The metal salt functional group including a sulfur (S) element may be a metal salt functional group including sulfonate (SO₃²⁻) or sulfate (SO₄²⁻). For example, the metal salt functional group including a sulfur (S) element may be any one among

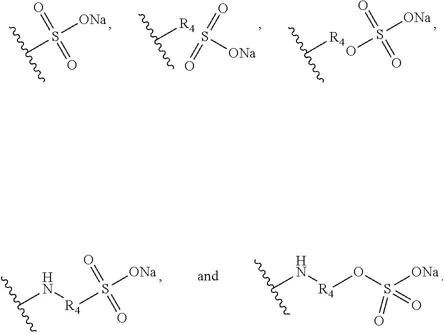

In this case, R₄ may be a hydrocarbon group of 1 to 10 carbon atoms.

The metal salt functional group including a phosphorus (P) element may be a metal salt functional group including phosphite (PO₃³⁻) or phosphate (PO₄³⁻). For example, the metal salt functional group including a phosphorus (P) element may be any one among

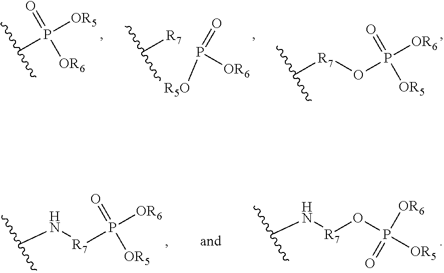

In this case, R₅ and R₆ may be each independently hydrocarbon of 1 to 10 carbon atoms or Na, and R₇ may be hydrocarbon of 1 to 10 carbon atoms.

For example, the substituent of the metal salt functional group including a boron (B) element may be any one among

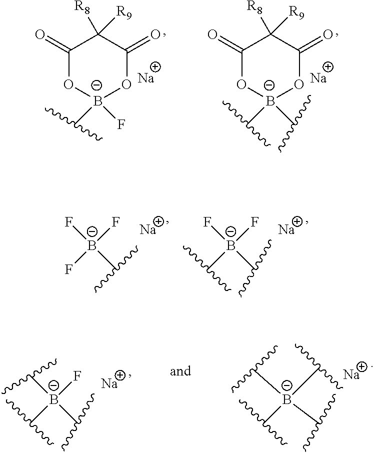

In this case, R₈ and R₉ may be each independently hydrocarbon of 1 to 10 carbon atoms or a halogen element.

For example, the composition ratio of the negative electrode active material and the mixture aqueous binder may be about 60:40 to about 99.5:0.5, or about 80:20 to about 99:1 by the weight ratio. For example, the composition ratio of the cellulose derivative composition and the SBR emulsion may be about 99:1 to about 1:99, or about 80:20 to about 40:60 based on the weight ratio.

Since in the conventional cellulose derivative (CMC), hydrophobic moieties unsubstituted with hydrophilic groups remain in a polymer chain, non-aqueous moieties present in the conventional cellulose derivative (CMC) have problems of forming microgels which are not dissolved in water but only arise swelling. If such microgels still remain during preparing an electrode slurry, scratch marks with line shapes may be formed on an electrode during coating, or the thickness of an electrode may be partially increase at an aggregation part of the microgels, and accordingly, short or leakage current might occur intensively.

However, according to the inventive concept, according to the substituent of the functional groups, effects of markedly reducing the formation of the aggregation of the microgels may be shown. In addition, the aqueous mixture binder composition to which a cellulose derivative substituted with the functional groups is applied, may reinforce the adhesion properties between active material particles and between an electrode and a current collector, to ultimately contribute to the improvement of the performance of a secondary battery.

The negative electrode 400 may further include a conductive material. The content of the conductive material may be about 0.5 wt % to about 5 wt % based on the total weight of the negative electrode 400. The conductive material may include at least one of conductive amorphous carbon, carbon nanotube, graphene, or a conductive polymer.

The electrolyte layer 200 may play the function of transferring ions to the positive electrode 100 and the negative electrode 400. The electrolyte layer 200 may include, for example, a liquid electrolyte. The electrolyte layer 200 may include a lithium salt and an organic solvent. The lithium salt may include at least one of LiPF₆, LiBF₄, LiSbF₆, LiAsF₆, LiClO₄, LiN(C₂F₅SO₂)₂, LiN(CF₃SO₂)₂, CF₃SO₃Li, LiC(CF₃SO₂)₃, or LiC₄BO₈. The organic solvent may include a cyclic carbonate or a linear carbonate. For example, the cyclic carbonate may include at least one of γ-butyrolactone, ethylene carbonate, propylene carbonate, glycerin carbonate, vinylene carbonate, or fluoroethylene carbonate. For example, the linear carbonate may include at least one of dimethyl carbonate, diethyl carbonate, ethyl methyl carbonate, dimethoxyethane, or dimethyl ethylene carbonate. The concentration of a lithium salt in the electrolyte layer 200 may be from about 1 M to about 3 M. In some embodiments of the inventive concept, the electrolyte layer 200 may further include an additive to improve the performance of a secondary battery. The additive may include fluoroethylene carbonate or vinylene carbonate.

The separator 300 may be disposed in the electrolyte layer 200. The separator 300 may prevent electric short between the positive electrode 100 and the negative electrode 400. For example, the separator 300 may include a separator base material. On the separator base material, a composition for coating a secondary battery separator may be applied. The separator base material may include, for example, at least one of polyolefin such as polyethylene and polypropylene, or cellulose. In some embodiments, the separator base material may include a porous polymer layer or a non-woven fabric.

FIG. 2 is a flowchart for explaining a method of preparing a composition for a secondary battery electrode according to an embodiment of the inventive concept. Hereinafter, overlapping parts as the above-described contents may be omitted.

Referring to FIG. 2, a method of preparing a composition for a secondary battery electrode according to an embodiment of the inventive concept may include: preparing an aqueous solution comprising a cellulose derivative composition comprising a compound represented by Formula 1 below (S1); adding an active material to the aqueous solution and stirring to prepare a first slurry (S2); and adding an emulsion to the first slurry and stirring (S3).

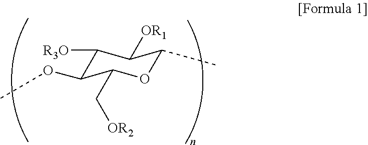

In Formula 1, R₁, R₂, and R₃ may be each independently any one among a metal salt functional group including a sulfur (S) element, a metal salt functional group including a phosphorus (P) element, a metal salt functional group including a boron (B) element, a metal salt functional group including a carboxymethyl group and hydrogen. At least one among R₁, R₂, and R₃ may be a metal salt functional group including a sulfur (S) element, a metal salt functional group including a phosphorus (P) element, a metal salt functional group including a boron (B) element, or a metal salt functional group including a carboxymethyl group. In this case, “n” may be an integer of 1 or more.

The repeating unit of the cellulose derivative may be a cellulose-based repeating unit group including a hydroxyl group, and R₁, R₂, and R₃ may be functional groups substituting for hydroxyl groups in the repeating unit group. For example, the metal of the metal salt may be Na.

In some embodiments, 0 to 2 among R₁, R₂, and R₃ may include hydrogen. In this case, if two among R₁, R₂, and R₃ are hydrogen atoms, the remaining one may be a metal salt functional group including a sulfur (S) element, a metal salt functional group including a phosphorus (P) element, or a metal salt functional group including a boron (B) element.

In some embodiments, 0 to 2 among R₁, R₂, and R₃ may include metal salt functional groups including carboxymethyl groups. In this case, if two among R₁, R₂, and R₃ are metal salt functional groups including carboxymethyl groups, the remaining one may be a metal salt functional group including a sulfur (S) element, a metal salt functional group including a phosphorus (P) element, or a metal salt functional group including a boron (B) element.

In some embodiments, 0 to 3 among R₁, R₂, and R₃ may include metal salt functional groups including a sulfur (S) element. In some embodiments, 0 to 3 among R₁, R₂, and R₃ may include metal salt functional groups including a phosphorus (P) element. In some embodiments, 0 to 3 among R₁, R₂, and R₃ may include metal salt functional groups including a boron (B) element.

The metal salt functional group including a sulfur (S) element may be a metal salt functional group including sulfonate (SO₃²⁻) or sulfate (SO₄²⁻). For example, the metal salt functional group including a sulfur (S) element may be any one among

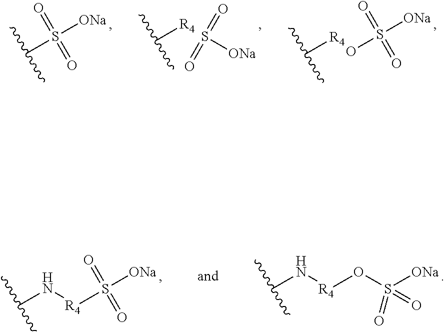

In this case, R₄ may be a hydrocarbon group of 1 to 10 carbon atoms.

The metal salt functional group including a phosphorus (P) element may be a metal salt functional group including phosphite (PO₃³⁻) or phosphate (PO₄³⁻). For example, the metal salt functional group including a phosphorus (P) element may be any one among

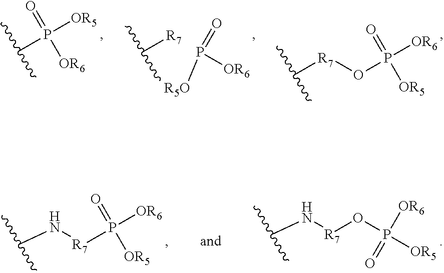

In this case, R₅ and R₆ may be each independently hydrocarbon of 1 to 10 carbon atoms or Na, and R₇ may be hydrocarbon of 1 to 10 carbon atoms.

For example, the substituent of the metal salt functional group including a boron (B) element may be any one among

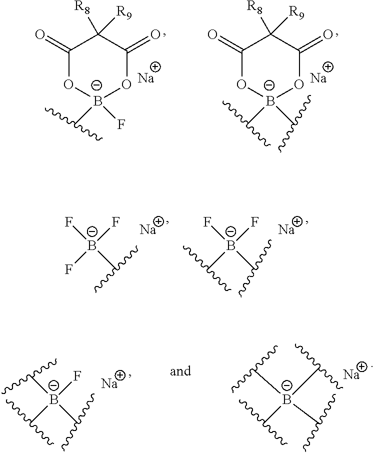

In this case, R₈ and R₉ may be each independently hydrocarbon of 1 to 10 carbon atoms or a halogen element.

In some embodiments, the preparation of an aqueous solution of the cellulose derivative may be performed by a synthetic method including activation.

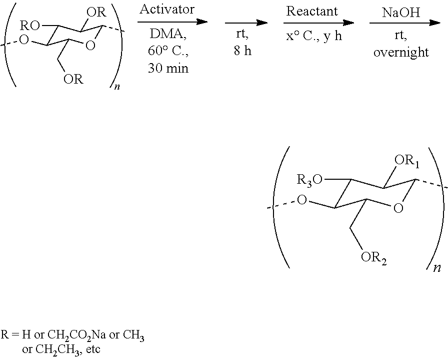

In some embodiments, the preparation of an aqueous solution of the cellulose derivative may be performed by a synthetic method excluding activation.

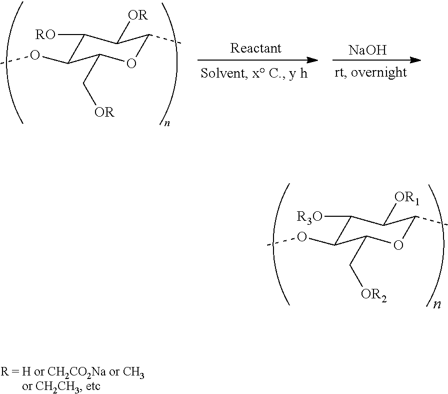

The preparation of the aqueous solution including the cellulose derivative composition (S1) may include adding a reactant to a precursor material of the cellulose derivative and performing reaction. The reaction may be performed in an organic solvent.

The precursor material of the cellulose derivative may include at least one of cellulose, methyl cellulose, ethyl cellulose, butyl cellulose, hydroxypropyl cellulose, cellulose nitrate, cellulose acetate, cellulose acetate propionate, cellulose acetate butyrate, carboxymethyl cellulose, or derivatives thereof.

The reactant may include at least one of a reactant including a sulfur (S) element, a reactant including a phosphorus (P) element, a reactant including a boron (B) element, or a reactant including a carboxymethyl group.

For example, the reactant including a sulfur (S) element may include at least one of a sulfur trioxide pyridine complex, a sulfur trioxide triethylamine complex, a sulfur trioxide trimethylamine complex, a sulfur trioxide N,N-dimethylformamide complex, a sulfur trioxide N-ethyldiisopropylamine complex, 2-chloroethanesulfonic acid, bromoethanesulfonic acid, 4-iodobenzenesulfonic acid, 3-iodobenzenesulfonic acid, 2-iodobenzenesulfonic acid, 4-bromobenzenesulfonic acid, 3-bromobenzenesulfonic acid, 2-bromobenzenesulfonic acid, saclofen, 4-chloroaniline-3-sulfonic acid, 5-amino-2-chloro-4-methylbenzenesulfonic acid, 5-amino-2-bromo-4-methylbenzenesulfonic acid, or bromaminic acid.

For example, the reactant including a phosphorus (P) element may include at least one of phosphoric acid, triethyl phosphate, diethyl phosphate, tripropyl phosphate, phosphorus(V) oxychloride, diethyl chlorophosphite, dimethyl chlorophosphite, diisopropyl chlorophosphite, diphenyl phosphoryl chloride, ethyl dichlorophosphate, diphenylphosphinic chloride, diethyl cyanophosphonate, or diethyl methyl phosphate.

For example, the reactant including a boron (B) element may include at least one of sodium fluoromalonate difluoroborate, sodium chloromalonate difluoroborate, sodium bromomalonate difluoroborate, sodium iodomalonate difluoroborate, sodium dimethylmalonate difluoroborate, sodium propenymalonate difluoroborate, sodium fluoromethylmalonate difluoroborate, sodium trifluoromethylmaloate difluoroborate, sodium phenylmalonate difluorobrate, or sodium propenylfluoromalonate difluoroborate.

For example, the organic solvent may include at least one of acetonitrile, dimethyl acetamide, dimethyl formamide, dimethyl sulfoxide, isopropanol, dioxane, or tetrahydrofuran.

The organic solvent may further include a base additive. For example, the base additive may include at least one of sodium hydroxide, sodium carbonate, triethylamine, trimethylamine, or sodium hydride.

The reaction temperature (x) of the reaction may be from about −20° C. to about 150° C., or from about 60° C. to about 110° C. The reaction time (y) of the reaction may be about 1 hour to 48 hours, or from about 1 hour to about 24 hours.

According to some embodiments, the preparation of the aqueous solution of the cellulose derivative by the synthetic method including the activation may include: adding an activation additive to a precursor material of the cellulose derivative and performing an activation process; and adding a reactant and performing reaction.

For example, the activation additive may include p-toluenesulfonic acid anhydride, or p-toluenesulfonic acid monohydrate.

The first slurry may be prepared by adding an active material to the aqueous solution of the cellulose derivative, and then, stirring and mixing (S2). For example, the active material may be a negative electrode active material and may have an active material particle shape.

By adding an emulsion to the first slurry and then, stirring and mixing a composition for a secondary battery electrode may be prepared (S3). For example, the emulsion may include a styrene-butadiene rubber (SBR) emulsion. The composition for a secondary battery electrode may have a slurry type.

If a cellulose derivative (CMC) substituted with sodium carboxylate, which is the conventional binder composition, is dissolved and stirred in water for a sufficient time period, a completely dissolved solution having a high viscosity (>800 cP @ 1 wt % aqueous solution) may be formed. However, if injected to a mass production line, in order to prepare a CMC aqueous solution in a short time and inject thereof to a slurry preparation process of a next step, a large amount of an aqueous binder for mass production is required to be completely dissolved in about 30 minutes to about 40 minutes. However, the aqueous binder is incompletely dissolved in practice, and there are problems in that many microgels are formed and a quite large amount of the microgels is present in a solution in a swollen state without being dissolved.

In this case, if the composition is applied to a preparation process of a negative electrode slurry without removing microgels present in the aqueous solution, scratches of an electrode manufactured together with aggregation phenomenon of non-uniform particles in an electrode are shown here and there during applying the slurry, and significant bad influences of the quality and performance of an electrode are induced. In order to solve the defects, stirring is required to be performed until microgels disappear, dissolving time of an aqueous binder solution is required to be increased, or a separate filtering apparatus for removing microgels is required.

In addition, according to the preparation method of the conventional composition for a secondary battery electrode, in case of mixing two binders at the same time, the dispersion of an SBR emulsion in an aqueous solution may become in disorder by the CMC substituted with an ionic group, and the aggregation phenomenon of the emulsion may arise. Due to such aggregation phenomenon, SBR particles may be non-uniformly distributed among active materials, the toughness of an electrode may be degraded, and an electrode in a brittle state may be formed.

However, according to the preparation method of the conventional composition for a secondary battery electrode, though prepared according to a mixing order, there are still problems of breaking or cracking of an electrode.

On the contrary, according to the inventive concept, by introducing sodium acid functional groups which make even stronger interaction with water than the conventional CMC, the wetting properties of water and a dissolution rate in water may be improved. In addition, the cellulose derivative binder aqueous solution according to the inventive concept may not form microgels. Accordingly, the preparation rate in a large amount of a cellulose derivative binder aqueous solution may be effectively increased within a limited process time, and preparation stability and reliability may be improved.

In addition, according to the inventive concept, in order to prepare the composition for a secondary battery electrode, an active material and an emulsion are mixed in order, and the agglomeration and aggregation of the SBR emulsion may be suppressed, while maintaining the dispersion of an SBR emulsion in a slurry at most.

The viscosity of the composition for a secondary battery electrode may be from about 1000 cP to about 9000 cP. If the viscosity of the composition for a secondary battery electrode is less than about 1000 cP, the mobility of the slurry of the composition for a secondary battery electrode may be maximized due to low viscosity, and though wetting properties with a current collector may increase, there are problems of forming an electrode thin. If the viscosity of the composition for a secondary battery electrode is greater than about 9000 cP, water in the slurry of the composition for a secondary battery electrode may be insufficient and volatilized during a coating process, the mobility of the slurry may be excessively reduced, and uniform coating on an electrode may not be performed continuously.

The method of manufacturing an electrode for a secondary battery according to an embodiment of the inventive concept may include: preparing an aqueous solution of a cellulose derivative represented by Formula 1; adding an active material to the aqueous solution and stirring to prepare a first slurry; adding an emulsion to the first slurry and stirring; and applying the composition for a secondary battery electrode on a current collector and drying. For example, the electrode for a secondary battery may be a negative electrode.

The explanation on the method of preparing the composition for a secondary battery electrode by adding the emulsion to the first slurry and stirring, is substantially the same as described above. A process of applying the composition for a secondary battery electrode prepared by the above-described preparation method onto current collector may be performed. For example, a process of applying the composition for a secondary battery electrode may include coating slurry onto current collector followed by roll pressing. For example, the application of the composition for a secondary battery electrode on the current collector may be performed by any one layer-thickening process among a gravure coating method, a small-diameter gravure coating method, a reverse roll coating method, a transfer roll coating method, a kiss coating method, a dip coating method, a knife coating method, an air doctor blade coating method, a blade coating method, a bar coating method, a die coating method, a screen printing method, and a spray coating method.

For example, the drying method of the composition for a secondary battery electrode applied may include hot air drying and then, drying under a reduced pressure. However, an embodiment of the inventive concept is not limited thereto, and any methods for completely removing water in a coated body may be used, without limitation. In order to satisfy the moisture content of several ppm or less in a liquid electrolyte after assembling a secondary battery cell and injecting the liquid electrolyte, sufficient drying is required. Accordingly, the process time of the drying under a reduced pressure may be about 12 hours or more. The temperature of the drying process may be about 80° C. to about 120° C. For example, in order to completely dry a water solvent, the drying may be performed at about 100° C. which is the boiling point of water.

The thickness of the electrode on which the composition for a secondary battery electrode is coated may be from about 50 μm to about 150 μm. If the thickness of the electrode is less than about 50 μm, there are problems in that the capacity design of a secondary battery cell is limited. If the thickness of the electrode is greater than about 150 μm, the impregnating rate of an electrolyte in the electrode may be reduced, and an impregnation time may increase, and the mobility of lithium ions in the electrode may be reduced, and ultimately, the performance and life characteristics of a secondary battery may be deteriorated.

For example, the porosity of a negative electrode layer through roll pressing of the electrode at room temperature may be from about 25% to about 40%.

### Example 1

Sulfation of cellulose derivative: 206.55 mg (0.85 mmol) of carboxymethyl cellulose was added to 5 mL of dimethyl acetamide (DMA) to prepare a dispersion solution, and 121.91 mg (0.64 mmol) of p-toluenesulfonic acid (activator) was added and mixed. The temperature was raised to about 50° C., and stirring was performed for about 30 minutes. Then, stirring was performed at room temperature for about 8 hours to finish activation, and 1.02 g (6.35 mmol) of a sulfur trioxide pyridine complex (reactant) was suitably added and reacted at room temperature for about 1 hour. After that, the reaction mixture was precipitated with ethanol and acetone, and the precipitate was dissolved in an aqueous solution of sodium hydroxide (NaOH). Impurities were removed by dialysis tubing, and water was removed under a reduced pressure. A precipitate was obtained with ethanol and acetone and vacuum dried at about 70° C. for about 24 hours to obtain a cellulose derivative (sulfated CMC, yield: 47%).

### Comparative Example 1

In order to compare substitution effects of a cellulose derivative composition of the inventive concept with a functional group, a commercial product, CMC was applied as a comparative example.

### Experimental Example 1

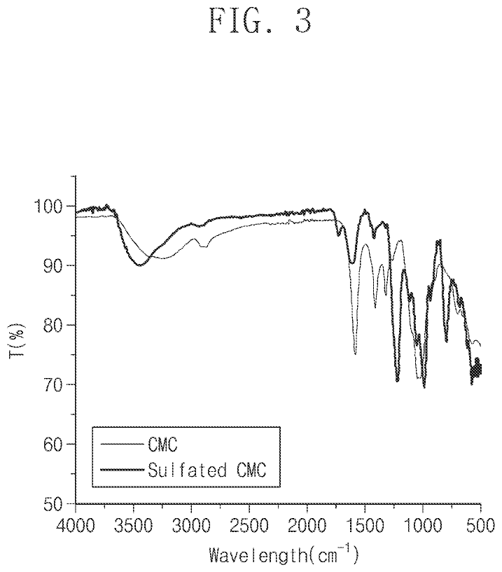

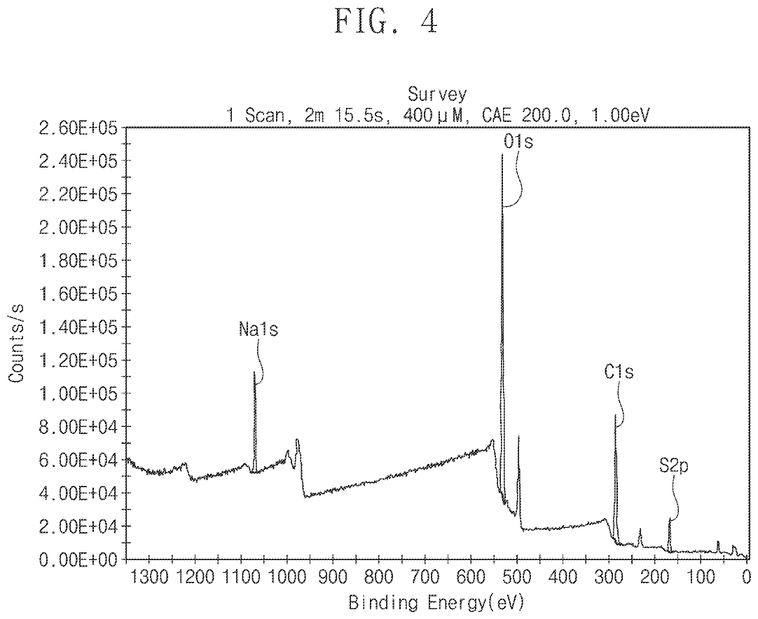

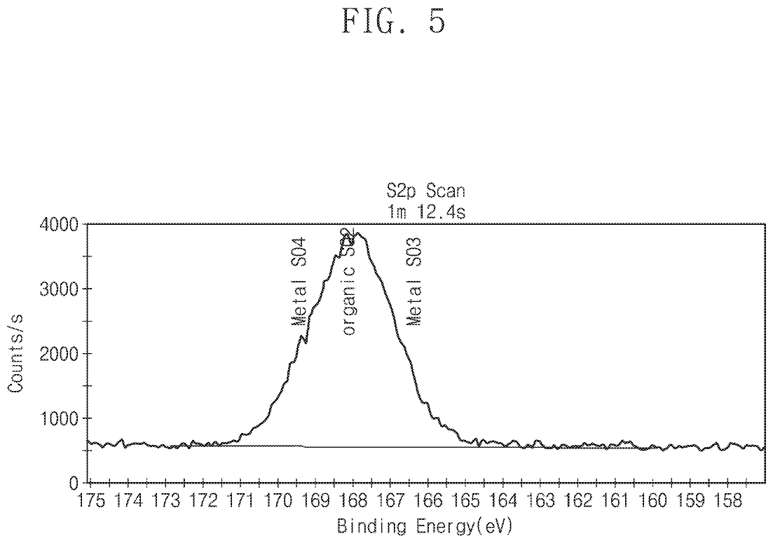

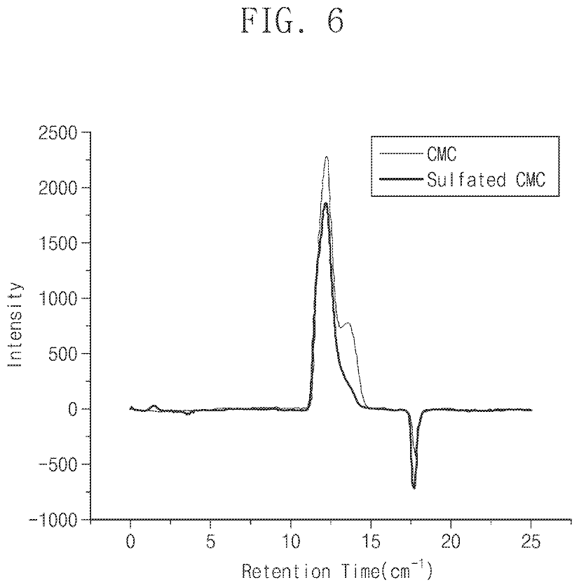

The results of the FT-IR spectrum, XPS data, S2p XPS data, and GPC data of the compound obtained in Example 1 (sulfated CMC), are shown in FIG. 3, FIG. 4, FIG. 5, and FIG. 6, respectively. The results of the FT-IR spectrum and GPC data of the compound of Comparative Example 1 (CMC) are shown in FIG. 3 and FIG. 6, respectively.

In Table 1 below, the GPC data of the compound obtained in Example 1 (sulfated CMC) and the compound of Comparative Example 1 (CMC) are shown (measured three times for each¹⁾).

TABLE 1

| | | | | Degree of substitution |
|---|---|---|---|---|
| Entry | Mn | Mw | Mz | of SO [symbol] Na [symbol] |
| sulfated | 943,953 ± | 4,073,015 ± | 11,588,491 ± | 2.30 |
| CMC | 9,525 | 24,570 | 212,904 | |
| CMC | 479,300 | 2,613,239 | 7,582,315 | 0 |

[symbol]

indicates data missing or illegible when filed

### Example 2

The same process as in Example 1 was performed except that the degree of substitution (DS) of the substituted sodium sulfate was 1.50, different from the compound obtained in Example 1.

### Example 3

The same process as in Example 1 was performed except that the degree of substitution (DS) of the substituted sodium sulfate was 0.52, different from the compound obtained in Example 1.

### Experimental Example 2

The molecular weight and the change of the degree of substitution of Comparative Example 1 and Example 1 to Example 3 are shown in Table 2 below.

TABLE 2

| | Comparative | | | |
|---|---|---|---|---|
| Division | Example 1 | Example 1 | Example 2 | Example 3 |
| Molecular weight | 479,300 | 943,953 ± | 782,845 ± | 584,658 ± |
| (Mₙ) | | 9,525 | 11,567 | 1,729 |
| Degree of substitution | 0 | 2.30 | 1.50 | 0.52 |

### Example 4

After preparing a mixture binder with an SBR emulsion based on the sodium sulfate-substituted cellulose derivative binder, synthesized in Example 1, a negative electrode slurry was prepared, and electrode coating was performed on a current collector. As a negative electrode active material, natural graphite particles having an average particle size of about 10 μm was used. The polymer solid content in the cellulose derivative binder aqueous solution of Example 1 was about 1 wt %, and a water solvent was added thereto to dilute to a 0.5 wt % solution and used. A slurry based on 10 g of a solute was prepared, and the weight ratio of the natural graphite and the cellulose derivative aqueous binder synthesized was set to about 98:1. After mixing a first slurry, an SBR emulsion was added, and the weight ratio of natural graphite:cellulose derivative aqueous binder synthesized: the solute of SBR emulsion was set to about 98:1:1. Accordingly, the weight ratio of the cellulose derivative and the SBR emulsion of about 50:50 was applied. That is, 9.8 g of the natural graphite and 100 g (1 wt % solution) of the aqueous binder solution of Example 1 were mixed, and then, 2.2 g of the SBR emulsion (solid content of 46%) was mixed. For uniform mixing, a stirring process was performed using a planetary mixer at about 2000 rpm for about 20 minutes. Zirconia balls of about 5 mm were added and stirred together for maximizing the dispersion of the natural graphite and for solving the aggregation phenomenon of SBR particles, and the viscosity of the slurry was controlled to about 1500 cP to about 3000 cP. Through a doctor blade method, a slurry coating process on a current collector was performed. By controlling the gap of a doctor blade to about 120 μm, a negative electrode with a thickness after drying of about 80 μm and with a final thickness of about 60 μm after roll pressing at room temperature was manufactured.

### Example 5

The same process as in Example 4 was performed except that the sodium sulfate-substituted cellulose derivative binder, synthesized in Example 2 instead of Example 1 was used.

### Example 6

The same process as in Example 4 was performed except that the sodium sulfate-substituted cellulose derivative binder, synthesized in Example 3 instead of Example 1 was used.

### Comparative Example 2

In order to compare the suitability of the mixture binders for a negative electrode of Example 4, Example 5, and Example 6, to which the cellulose derivatives of Example 1, Example 2, and Example 3 were applied, respectively, a commercial product, SBR emulsion/CMC mixture binder was prepared as Comparative Example 2. The polymer solid content in a CMC aqueous solution was 1 wt %, and a water solvent was added thereto to dilute to a 0.5 wt % solution and used. A slurry based on 10 g of a solute was prepared, and the weight ratio of the natural graphite and the CMC aqueous binder was set to about 98:1. After mixing a first slurry, an SBR emulsion was added, and the solute weight ratio of natural graphite:CMC aqueous binder:SBR emulsion was set to about 98:1:1. Accordingly, the weight ratio of the CMC and the SBR emulsion of about 50:50 was applied. That is, 9.8 g of the natural graphite and 100 g (1 wt % solution) of the CMC binder aqueous solution were mixed, and then, 2.2 g of the SBR emulsion (solid content of 46%) was mixed. For uniform mixing, a stirring process was performed using a planetary mixer at about 2000 rpm for about 20 minutes. Zirconia balls of about 5 mm were added and stirred for maximizing the dispersion of the natural graphite and for solving the aggregation phenomenon of SBR particles, and the viscosity of the slurry was controlled to about 1500 cP to about 300 cP. Through a doctor blade method, a slurry coating process on a current collector was performed. By controlling the gap of a doctor blade to about 120 μm, a negative electrode with a thickness after drying of about 80 μm, and with a final thickness of about 60 μm was manufactured after roll pressing at room temperature.

### Experimental Example 3

The peel test of the negative electrode manufactured according to Example 4, Example 5, Example 6 and Comparative Example 2 were measured and shown in Table 3 below.

TABLE 3

| | Comparative | | | |
|---|---|---|---|---|
| Division | Example 2 | Example 4 | Example 5 | Example 6 |
| Thickness (μm) | 60.1 | 60.2 | 59.9 | 60.1 |
| Adhesion (g_{f}/cm) | 113 | 134 | 141 | 138 |

Referring to Table 3 above, it could be confirmed that Example 4 to Example 6, in which the cellulose derivative binder of the inventive concept was applied, showed improved adhesion by about 24% or more at most when compared to the conventional SBR/CMC binder (Comparative Example 2).

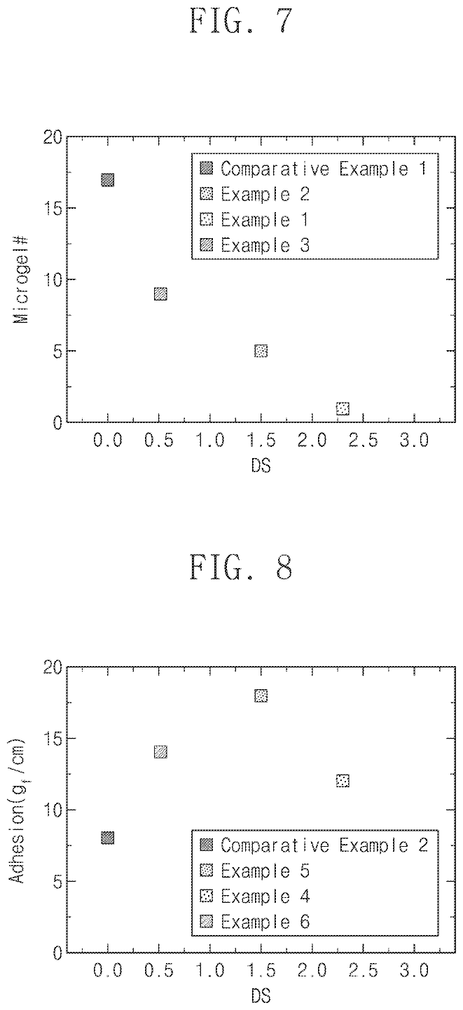

FIG. 7 shows measured results on the number of microgels with the naked eye after applying solutions immediately after stirring and dissolving the same amounts of the cellulose derivatives of Example 1 to Example 3, and the CMC of Comparative Example 1 for about 20 minutes, on transparent films. Referring to FIG. 7, it could be confirmed that cases of substituting with sodium acid functional groups (Example 1 to Example 3) showed increased wettability of a solvent and dissolution rate, and reduced number of microgels.

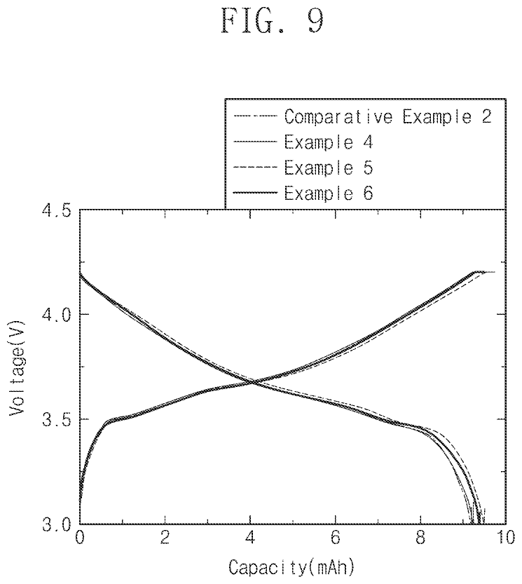

FIG. 8 shows measured results on adhesion through a peel test after saturation immersing each negative electrode to which each of the mixture binders of SBR emulsion/cellulose derivatives of Example 4 to Example 6, and the mixture binder of SBR emulsion/CMC of Comparative Example 2 is applied, in a liquid electrolyte. In Comparison to Comparative Example 2, it could be confirmed that the mixture binders of Example 4 to Example 6 showed better adhesion.

FIG. 9 is a graph on initial discharge capacity after constituting a single cell using each negative electrode to which each of the mixture binders of Example 4 to Example 6, and the mixture binder of Comparative Example 2 is applied. It could be confirmed that Example 4 to Example 6 showed somewhat large initial discharge capacity when compared to Comparative Example 2, but there was no great difference.

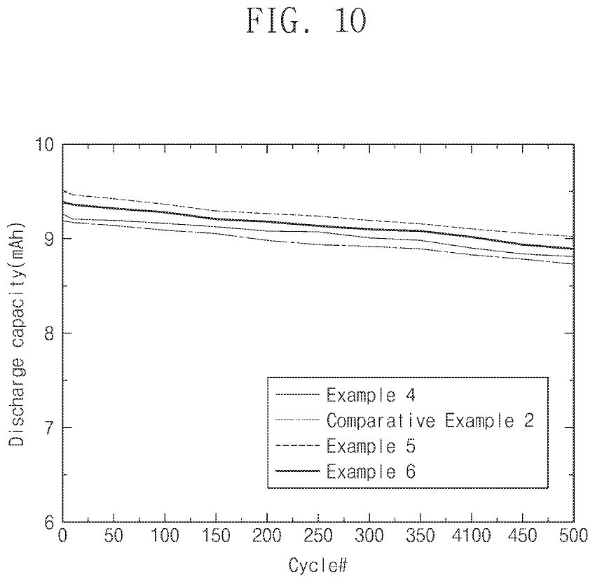

FIG. 10 is a graph on life characteristics after constituting a single cell using each negative electrode to which each of the mixture binders of Example 4 to Example 6, and the mixture binder of Comparative Example 2 is applied. It could be confirmed that during repeating charging and discharging 500 times, all of Example 4 to Example 6 and Comparative Example 2 showed similar retention rates of capacity.

According to the inventive concept, by introducing sodium acid functional groups which make even stronger interaction with water in a cellulose derivative composition for a secondary battery binder, the wetting properties of water of sodium ion substituted functional groups and a dissolution rate in water may be improved. Accordingly, the preparation rate in a large amount of a cellulose derivative binder aqueous solution may be effectively increased within a limited process time. In addition, the cellulose derivative composition for a secondary battery binder may be prepared by a relatively simple process, and preparation cost may be effectively saved.

The cellulose derivative composition for a secondary battery binder according to the inventive concept may not form microgels, particularly, the formation of microgels may be suppressed or minimized though dissolution is performed within a limited process time, and manufacturing stability and reliability on a manufacturing process of a negative electrode may be improved.

The composition for a secondary battery electrode according to the inventive concept may improve the adhesion strength between active material particles during manufacturing a negative electrode and reinforce the adhesion between the negative electrode and a current collector, thereby increasing the loading amount of an active material in the negative electrode and the thickness of an electrode. Ultimately, according to the inventive concept, the expanded design of cell capacity may be possible, and the manufacture of a lithium secondary battery based on a liquid electrolyte which has improved energy density may be possible. Particularly, the reinforcement of the adhesion between active material particles and the adhesion between the composition for an electrode and the current collector according to the sodium acid functional group, may contribute to the improvement of the long-life characteristics and rate capability of a secondary battery cell.

Although the embodiments of the present invention have been described, it is understood that the present invention should not be limited to these embodiments, but various changes and modifications can be made by one ordinary skilled in the art within the spirit and scope of the present invention as hereinafter claimed.

What is claimed is:

1. A cellulose derivative composition for a secondary battery binder, comprising a compound represented by the following Formula 1: 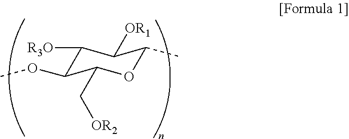
in Formula 1,
R₁, R₂, and R₃ are each independently any one among a metal salt functional group comprising a sulfur (S) element, a metal salt functional group comprising a phosphorus (P) element, a metal salt functional group comprising a boron (B) element, a metal salt functional group comprising a carboxymethyl group and hydrogen,
at least one among R₁, R₂, and R₃ is a metal salt functional group comprising a sulfur (S) element, a metal salt functional group comprising a phosphorus (P) element, a metal salt functional group comprising a boron (B) element, or a metal salt functional group comprising a carboxymethyl group, and
“n” is an integer of 1 or more.

2. The cellulose derivative composition for a secondary battery binder of claim 1, wherein
the metal salt functional group comprising a sulfur (S) element is a metal salt functional group comprising sulfonate (SO₃²⁻) or sulfate (SO₄²⁻), and
the metal salt functional group comprising a phosphorus (P) element is a metal salt functional group comprising phosphite (PO₃³⁻) or phosphate (PO₄³⁻).

3. The cellulose derivative composition for a secondary battery binder of claim 1, wherein the metal salt functional group comprising a sulfur (S) element is any one among 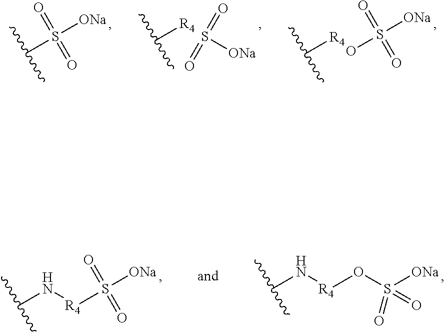
where R₄ is a hydrocarbon group of 1 to 10 carbon atoms.

4. The cellulose derivative composition for a secondary battery binder of claim 1, wherein the metal salt functional group comprising a phosphorus (P) element is any one among 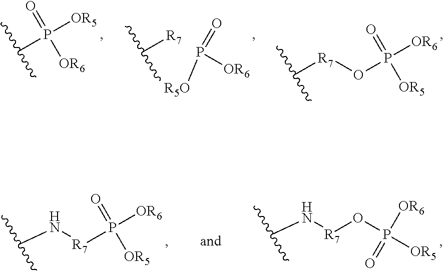
where R₅ and R₆ are each independently hydrocarbon of 1 to 10 carbon atoms or Na, and
R₇ is hydrocarbon of 1 to 10 carbon atoms.

5. The cellulose derivative composition for a secondary battery binder of claim 1, wherein the metal salt functional group comprising a boron (B) element is any one among 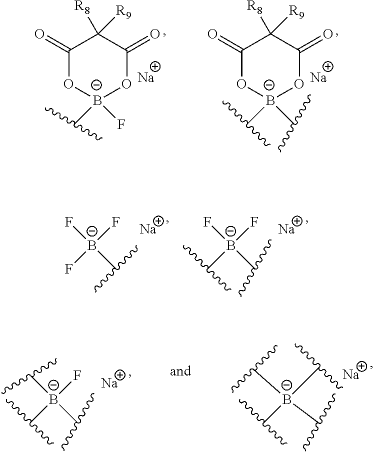
where R₈ and R₉ are each independently hydrocarbon of 1 to 10 carbon atoms or a halogen element.

6. The cellulose derivative composition for a secondary battery binder of claim 1, wherein a metal of the metal salt is Na.

7. A method of preparing a composition for a secondary battery electrode, the method comprising:
preparing an aqueous solution comprising a cellulose derivative composition comprising a compound represented by the following Formula 1;
adding an active material to the aqueous solution of the cellulose derivative and stirring to prepare a first slurry; and
adding an emulsion to the first slurry and stirring: 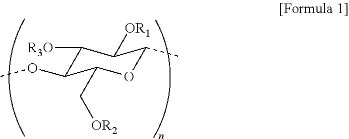
in Formula 1,
R₁, R₂, and R₃ are each independently any one among a metal salt functional group comprising a sulfur (S) element, a metal salt functional group comprising a phosphorus (P) element, a metal salt functional group comprising a boron (B) element, a metal salt functional group comprising a carboxymethyl group and hydrogen,
at least one among R₁, R₂, and R₃ is a metal salt functional group comprising a sulfur (S) element, a metal salt functional group comprising a phosphorus (P) element, a metal salt functional group comprising a boron (B) element, or a metal salt functional group comprising a carboxymethyl group, and
“n” is an integer of 1 or more.

8. The method of preparing a composition for a secondary battery electrode of claim 7, wherein the emulsion is a styrene-butadiene rubber (SBR) emulsion.

9. The method of preparing a composition for a secondary battery electrode of claim 7, wherein the active material comprises at least one of graphite, hard carbon, or soft carbon.

10. The method of preparing a composition for a secondary battery electrode of claim 7, wherein the aqueous solution comprising the cellulose derivative composition comprises an organic solvent, and
the organic solvent comprises at least one of acetonitrile, dimethyl acetamide, dimethyl formamide, dimethyl sulfoxide, isopropanol, dioxane, or tetrahydrofuran.

11. The method of preparing a composition for a secondary battery electrode of claim 7, wherein the preparation of the aqueous solution comprising the cellulose derivative composition comprising a compound represented by Formula 1, comprises adding a reactant to a precursor material of the cellulose derivative, and performing reaction.

12. The method of preparing a composition for a secondary battery electrode of claim 11, wherein the precursor material of the cellulose derivative comprises at least one of cellulose, methyl cellulose, ethyl cellulose, butyl cellulose, hydroxypropyl cellulose, cellulose nitrate, cellulose acetate, cellulose acetate propionate, cellulose acetate butyrate, carboxymethyl cellulose, or derivatives thereof.

13. The method of preparing a composition for a secondary battery electrode of claim 11, wherein the reactant comprises at least one of a reactant comprising a sulfur (S) element, a reactant comprising a phosphorus (P) element, a reactant comprising a boron (B) element, or a reactant comprising a carboxymethyl group.

14. The method of preparing a composition for a secondary battery electrode of claim 13, wherein the reactant comprising a sulfur (S) element comprises at least one of a sulfur trioxide pyridine complex, a sulfur trioxide triethylamine complex, a sulfur trioxide trimethylamine complex, a sulfur trioxide N,N-dimethylformamide complex, a sulfur trioxide N-ethyldiisopropylamine complex, 2-chloroethanesulfonic acid, bromoethanesulfonic acid, 4-iodobenzenesulfonic acid, 3-iodobenzenesulfonic acid, 2-iodobenzenesulfonic acid, 4-bromobenzenesulfonic acid, 3-bromobenzenesulfonic acid, 2-bromobenzenesulfonic acid, saclofen, 4-chloroaniline-3-sulfonic acid, 5-amino-2-chloro-4-methylbenzenesulfonic acid, 5-amino-2-bromo-4-methylbenzenesulfonic acid, or bromaminic acid.

15. The method of preparing a composition for a secondary battery electrode of claim 13, wherein the reactant comprising a phosphorus (P) element comprises at least one of phosphoric acid, triethyl phosphate, diethyl phosphate, tripropyl phosphate, phosphorus(V) oxychloride, diethyl chlorophosphite, dimethyl chlorophosphite, diisopropyl chlorophosphite, diphenyl phosphoryl chloride, ethyl dichlorophosphate, diphenylphosphinic chloride, diethyl cyanophosphonate, or diethyl methyl phosphate.

16. The method of preparing a composition for a secondary battery electrode of claim 13, wherein the reactant comprising a boron (B) element comprises at least one of sodium fluoromalonate difluoroborate, sodium chloromalonate difluoroborate, sodium bromomalonate difluoroborate, sodium iodomalonate difluoroborate, sodium dimethylmalonate difluoroborate, sodium propenymalonate difluoroborate, sodium fluoromethylmalonate difluoroborate, sodium trifluoromethylmaloate difluoroborate, sodium phenylmalonate difluorobrate, or sodium propenylfluoromalonate difluoroborate.

17. The method of preparing a composition for a secondary battery electrode of claim 7, wherein the preparation of the aqueous solution comprising the cellulose derivative composition comprises: adding an activation additive to the precursor material of the cellulose derivative and performing an activation process; and adding a reactant and performing reaction.

18. The method of preparing a composition for a secondary battery electrode of claim 17, wherein the activation additive comprises p-toluenesulfonic acid anhydride, or p-toluenesulfonic acid monohydrate.

19. The method of preparing a composition for a secondary battery electrode of claim 7, wherein a viscosity of the composition for a secondary battery electrode is from about 1000 cP to about 9000 cP.

20. A secondary battery comprising:
a positive electrode;
a negative electrode; and
an electrolyte layer disposed between the positive electrode and the negative electrode,
wherein the negative electrode comprises an active material and a mixture binder,
the mixture binder comprises a cellulose derivative composition comprising a compound represented by the following Formula 1 and a styrene-butadiene rubber (SBR) emulsion: 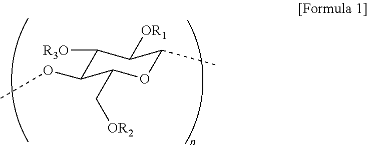
in Formula 1,
R₁, R₂, and R₃ are each independently any one among a metal salt functional group comprising a sulfur (S) element, a metal salt functional group comprising a phosphorus (P) element, a metal salt functional group comprising a boron (B) element, a metal salt functional group comprising a carboxymethyl group and hydrogen,
at least one among R₁, R₂, and R₃ is a metal salt functional group comprising a sulfur (S) element, a metal salt functional group comprising a phosphorus (P) element, a metal salt functional group comprising a boron (B) element, or a metal salt functional group comprising a carboxymethyl group, and
“n” is an integer of 1 or more.
